(19) United States
(12) Patent Application Publication
(10) Pub. No.: US 2017/0325474 A1
(43) Pub. Date: Nov. 16, 2017

(54) Method for the Extraction of Oily Components from Coffee Beans and/or of Residual Materials of Coffee Production

(71) Applicant: GCR - Global Commodity Resources UG (haftungsbeschränkt), Neukirch OT Schmorkau (DE)

(72) Inventors: Anja Glisovic, Lübeck (DE); Stefan Handrick, Neukirch OT Schmorkau (DE); Frank Hinrichs, Oldenburg (DE)

(21) Appl. No.: 15/532,510

(22) PCT Filed: Dec. 15, 2015
(86) PCT No.: PCT/EP2015/079739

§ 371 Date: Jun. 2, 2017

(30) Foreign Application Priority Data
Dec. 15, 2014 (DE) 10 2014 225 940.1

(51) Int. Cl. A23F 5/48; C11B 3/12; C11B 1/10

(52) U.S. Cl. CPC A23F 5/483; C11B 1/10; C11B 3/12

(57) ABSTRACT

A method for moist extraction of oil-containing components from coffee beans and/or residues from coffee production, wherein the coffee beans and/or residues from coffee production with a residual moisture content of 10 to 95 percent by mass, measured with reference to the total mass of the coffee beans and/or residues from coffee production are extracted with a mixture of extraction agents consisting of at least one each of a polar and a nonpolar solvent.

### CROSS REFERENCE TO RELATED APPLICATIONS

This application is the U.S. national stage of International Application No. PCT/EP2015/079739, filed on Dec. 15, 2015. The international application claims the priority of DE 102014225940.1 filed on Dec. 15, 2014; all applications are incorporated by reference herein in their entirety.

### BACKGROUND

The present invention relates to a method for extracting oil-containing components from coffee beans and/or residues from coffee production with a residual moisture content.

In the current state of the art, oil—particularly vegetable oil—is typically obtained by pressing or extraction. For this purpose, the oil-containing material is first dried and ground (conditioned) and afterwards subjected to one or both methods. In the latter case, it is usually pressed first and then undergoes extraction. If the materials have a high oil content, such as rapeseed, for example, pressing has the advantage of being technically relatively simple and efficient enough to cover costs and return a profit when used. With pressing, up to 90% of the oil can be recovered from a material. The drawback with this method is that suspended solids are also pressed out together with the oil, so the oil must still undergo several purifying steps.

Oil extraction is typically carried out using hexane. The advantages of extraction are its high level of efficiency and the purity of the oil. Up to 98% of the oil can be extracted and after the extraction agent has been distilled out, this oil is pure and normally does not require any further processing. The extraction of oil from vegetable materials using hexane as the solvent is currently the predominant industrial standard and has two significant aspects which directly influence the oil yield and therewith also the efficiency and profitablity of the method. The first aspect is solvent efficiency, this describes how much oil is accessible and can be dissolved with a given quantity of solvent and extraction material over what period of time. This aspect is affected heavily by the type of solvent, the composition of the oil, the working temperature the conditioning of the oil-containing material, the moisture content and a number of other less important factors. The second aspect is how completely the solvent-oil mixture (miscella) can be separated from the extraction material. Ideally, at the end of the extraction process the material contains no oil at all any more, but pure solvent, which is recovered again in a subsequent step.

Extraction is made technically possible by extraction systems which may range in size from a small Soxhlet extractor in the laboratory to industrial scale counterflow plants. Of these, the most commonly used extractor type for extracting oil are percolation systems. In percolation systems, a liquid flows under gravity down through a porous bed of material onto a sieve diaphragm, a similar principle to preparing filter coffee. As the solvent (usually hexane) flows (seeps) downwards through the bed of oil-containing material, the oil is dissolved in the solvent, the miscella forms and is collected below the sieve diaphragm. For reasons of fire protection, the systems are usually operating with a slight negative pressure and close to the boiling point of hexane, at 69° C., so that the temperature-dependent dissolving and diffusion processes take place as quickly as possible. With the correct choice of flake size, residual moisture, extraction agent and temperature, dissolving efficiency up to 98-99% can be achieved here. This principle is common to all percolation systems, although different variants of percolation extraction systems have emerged in response to the need to achieve satisfactory separation completeness for a certain material throughput, and these differ significantly according to their manufacturer and application. One of the features they do have in common is that the miscella with the highest proportion of oil is always added to the extraction material at the beginning of the process, when the oil content is also highest. The miscella is then used with successively lower oil proportions in order to reduce the oil content of the extraction material in each step. In the final step, pure solvent is used for flushing, only absorbing the smallest quantities of oil as it percolates through the material and so producing the miscella with the lowest proportion of oil. The extracted material is then discharged and the extraction agent is removed from the oilless extraction material and recovered by steam distillation.

In their simplest form, the batch systems, which are often found in laboratories and research facilities due to their low material throughput, such as the SPX e&e pilot extraction plant, the extraction material is placed in a permeable strainer basket. The solvent is added from above and is able to percolate through the material. Because of its design, the miscella can be drawn off continuously. Alternatively, the extractor can also be flooded with solvent and then only drawn off after a certain residence time. In this variant, separate flushes of the extraction material are used, so that the oil content of the miscella and the extraction material is reduced with each successive flush. The number of flushes possible is linked directly to the number and volume of the tanks which are available for storing the solvent and the miscella with various proportions of oil. In some designs, it is also possible to remove the solvent from the extraction material in the extraction vessel itself, without discharging it, by introducing hot steam. Batch systems belong to the group of “deep bed systems”.

Flat bed systems are a different type, which are designed to process a continuous stream of material, and are accordingly used in large plants. In this case, the extraction material is deposited on a sieve diaphragm with a relatively shallow bed depth of 0.3 to 1.2 m, so the extraction agent added from above can percolate through the material bed. In this case, the sieve diaphragm may be designed as a conveyor belt and continuously move with the material, or it may also have a stationary form, as a channel. In this case, the extraction material is advanced by screw mechanisms or chain hoists. In both variants, a vessel divided into sections for collecting the miscella is disposed below the sieve diaphragm. The miscella is pumped from one section onto the material in the respective following section and collected. The number of sections in this arrangement is determined by the design and the material, and is usually between four and twelve, seven or eight sections being the most commonly used number. The first section of the miscella tank—above which the fresh material that has just been discharged lies—contains the miscella with the highest proportion of oil, which is not used for extraction again, but is forwarded for distillation and oil recovery. In the last section, positioned below the material that is treated with fresh/pure solvent and then discharged, is the miscella with the lowest proportion of oil. The advantage of these systems consists in their continuous operation. However, compared with the batch systems they are subject to rather higher safety standards, because in order to remove the solvent by steam distillation the oilless extraction material containing hexane must be discharged from the extractor.

One requirement common to all industrially applicable methods is that the oil containing materials, whether they be oil seeds, oil fruits or oil sands, should have a water content of less than 20%, preferably less than 10%, and particularly about 7% to enable efficient oil recovery. If the proportion of water is too high during pressing, mainly water and only a small proportion of the oil is pressed out of the material. A high water content is similarly unfavourable for oil extraction using hexane or another non-polar solvent, such as gasoline or kerosene. If the proportion of water is too high (>10%), the water prevents the hydrophobic solvent from penetrating the material and thus also dissolving the oil. The recoverable fraction of the oil may thus fall to a level at which the costs of extraction are no longer covered, and the recovery of the oil is not financially viable. In order for the oil recovery to be financially profitable using the methods described, the water fraction must be reduced correspondingly by dry storage or active drying. Particularly when active drying is involved, considerable amounts of energy must be used to dry the material until a suitable water content level is reached. This is a critical factor whenever the raw material has a high water fraction of more than 20% and due to this water content tends to ferment or rot, thus becoming unusable. This tendency is particularly prevalent with organic materials, such as algae, freshly harvested oil seeds and oil-containing waste products from the food industry, such as coffee grounds.

If a material contains for example 30 wt % oil in the dry mass and has a water content of 55 wt % in the raw state, the following fractions are present in a metric tonne of moist material: 550 kg water, 315 kg base material and 135 kg oil. Accordingly, in order to lower the moisture level in the material to 10%, it would be necessary to evaporate 500 kg, that is to say half a metric tonne of water. If this is not possible with long storage periods, energy must be applied, which is associated with significant costs and may also impair the quality of the oil due to oxidative stress. Given the evaporation enthalpy of water in the order of 2.26 MJ/kg, at least 1130 MJ (500 kg·2.26 MJ/kg) would be needed to dry the material, requiring the application of at least 28.25 kg natural gas with a calorific value of 40 MJ/kg, entailing significant cost and consumption of resources. In times of rising energy prices and growing environmental awareness, a way to extract oil from moist raw materials without drying beforehand or using expensive specialised equipment is desirable.

Methods are known from patents DD 229148 A1, from 1984 and U.S. Pat. No. 8,273,248 B1, from 2012, with which oil can be recovered from materials with a higher moisture content.

DD 229 148 A1 describes a method that enables sufficiently efficient extraction of oil from material with water content up to 20%. This is achieved by pretreating the extraction material with alcohol or alcohol mixtures, wherein the quantity alcohol added should be equivalent to between 5 and 7% of the water fraction in the extraction material. The treatment with alcohol is followed by simple extraction with hexane or another alkane or alkane mixture (gasoline, kerosene).

U.S. Pat. No. 8,273,248 B1 describes a method intended specifically for extracting oil from algae, consisting of several consecutive extraction steps after a drying step. First, the water content is reduced and alcohol or an alcohol mixture is added to the algae. Then, hexane, another alkane or an alkane mixture is added. The individual fractions are then mixed with each other and allowed to rest. While the mixture rests, the alkane phase and the water-alcohol phase undergo phase separation and are separated. Oil and proteins can be recovered from the phases. The process must be repeated several times for efficient recovery. The process described in patent U.S. Pat. No. 8,273,248 B1 also requires the use of special extraction plants equipped with systems for separating the phases. While both methods are capable of recovering oil from moist materials, both still require either energy-intensive drying steps, multiple extraction and separation steps, or special equipment. These are all factors that entail high costs and may render the oil recovery unprofitable.

Patent WO 2012/138382 A1 discloses a method for extracting polar lipids from algae by using various extraction agents and particularly solvents with an alcohol surplus. In particular, no vegetable oils in the sense of triglycerides (neutral lipids) and fatty acids, but only polar lipids are extracted from the moist material. Disadvantageous dewatering and drying steps constitute an integral part of the process described, whereas in the present invention these are omitted and/or reduced to a minimum.

Document EP 0617119A2 describes a method for simultaneous extraction of hydrophobic triterpenoids such as azadirachtin and oil from the dry seed of the neem tree. A drawback of this method is that only dry materials are extracted, and the disclosed extraction solutions all contain excess alcohol. The method represented is not optimised for the recovery of oil, but rather for the recovery of hydrophilic components.

Patent DE 69623762 T2 describes a method for recovering terpenes such as cafestol esters, kahweol esters and isocafestol esters by treating coffee grounds with phosphoric acid and subsequent extraction of the terpenes. A disadvantage of the method is that the coffee grounds must be dried before the extraction. The oil extracted at the same time is considered an impurity in the terpenes and is not intended to be recovered from the coffee grounds.

US 2010/0287823 A1 discloses a method for recovering biofuels from ground coffee. In this method, the coffee is first treated with water and then treated with an organic solvent such as methanol, ethanol, hexane or mixtures of organic solvents to recover the triglycerides. In one embodiment, the water is separated from the ground coffee before the extraction by freeze drying or distillation for example.

### SUMMARY

The invention relates to a method for moist extraction of oil-containing components from coffee beans and/or residues from coffee production, wherein the coffee beans and/or residues from coffee production with a residual moisture content of 10 to 95 percent by mass, measured with reference to the total mass of the coffee beans and/or residues from coffee production are extracted with a mixture of extraction agents consisting of at least one each of a polar and a nonpolar solvent.

### DETAILED DESCRIPTION

The object underlying the present invention is to provide a simple, universally applicable, efficient and economical method for extracting oil-containing components from coffee beans that are still moist and/or moist residues from coffee production.

The object is solved with a method for the moist extraction of oil-containing components from coffee beans and/or residues of coffee production, wherein the coffee beans and/or residues from coffee production have a residual moisture content of 10 to 95 percent by mass, particularly preferably 30 to 85 percent by mass, most particularly preferably 45 to 85 percent by mass measured against the total mass of the coffee beans and/or residues from coffee production, with a mixture of extraction agents consisting of at least one polar and one nonpolar solvent, and wherein the at least one nonpolar solvent constitutes a proportion of 45 to 95 vol % of the mixture of extraction agents measured with respect to the total volume of the extraction agent.

For the purposes of the invention, the term extraction refers to the elution of at least one substance from the extraction material of coffee beans and/or residues from coffee production with a liquid mixture of extraction agents. Moist extraction denotes an extraction process in which moist extraction material with a residual moisture content is used.

According to the invention, oil-containing components refers to all substances that can be extracted from the extraction material of coffee beans and/or residues of coffee production with the aid of the mixture of extraction agents according to the invention. The oil-containing components are preferably fatty acid esters, particularly triglycerides and vegetable fats.

For the purposes of the invention, coffee beans refers to all types of coffee beans, both roasted and unroasted and mixtures thereof. The coffee beans may be pretreated, for example sorted or ground. Ground coffee beans that have not been extracted/brewed are also referred to as coffee flour.

Within the meaning of the invention, residues from coffee production comprise all types of residues (including coffee residues), both waste and byproducts from the coffee industry. They include for example coffee grounds, coffee powder, separator and decanter slurries and mixtures thereof. Residues are produced for example during the industrial manufacture of instant coffee as well as in domestic households or the hospitality business.

The industrial manufacture of instant coffee essentially comprises the following steps, wherein detailed features of the technical design may vary from one company to another: The beans are roasted and ground to make coffee flour. The coffee flour is then extracted (brewed) multiple times with hot water and optionally under pressure, yielding a coffee extract (also coffee in layman's terms) and coffee grounds (brewed coffee powder). The coffee extract is then purified of coffee ground residues in decanters and separators, the remaining coffee grounds is called separator and decanter slurry. Coffee extract residues are removed from the coffee grounds using belt presses or other equipment, and after purification with decanters and separators returned to production. Them the coffee extract is concentrated and freeze- or spray-dried, yielding instant coffee powder. The coffee grounds and the separator and decanter slurries are treated as waste in the industry and are sent for thermal processing. Because of their high water and oil content, they may advantageously undergo the method according to the invention.

Within the meaning of the invention, coffee grounds refers to the remains of the coffee, particularly the coffee powder and/or coffee flour, after it has undergone a brewing process, for example. Coffee grounds are produced for example when drinking coffee is prepared, but also as a waste product in the manufacture of instant coffee.

Mixtures of coffee beans and the remains from coffee production may also be used advantageously.

Within the meaning of the invention, the residual moisture content is the water content in the coffee beans and/or the residues from coffee production.

A mixture of extraction agents is a mixture of solvents that may be used for extracting the oil-containing components. Advantageously the oil-containing components are at least partly eluted in the mixture of extraction agents. After extraction, the extracted oily components are present in the mixture of extraction agents in dissolved and/or undissolved form. The mixture of extraction agents consists of one polar and one nonpolar solvent. Solvents are classified according to their polarity (hydrophily). Within the meaning of the invention, the terms polar and nonpolar refer to which of two solvents is comparatively the more polar or more nonpolar solvent. This can be determined with the aid of the elutropic series, for example.

Preferably, the polar and the nonpolar solvent can be mixed with each other without limitation, but at least in the volumetric proportions indicated. The polar solvent is preferably miscible with the at least one oil-containing component that is to be extracted.

Gasoline, kerosene, toluene, an alkane having a chain length of 5 to 25 carbon atoms or a mixture thereof is preferably used as at least one nonpolar solvent. Particularly preferably, an alkane having a chain length of 5 to 12 carbon atoms, most particularly preferably selected from n-pentane, iso-pentane, iso-hexane, n-heptane, n-octane, still more preferably n-hexane, is used.

For the purposes of the invention, alkanes are considered to be saturated, acyclic hydrocarbons having the general formula CₙH₂ₙ₊₂, wherein n is an integer. The alkane may consist either of a linear carbon skeleton as well as isomers thereof, also of branched carbon chains.

Preferably, an alcohol having a chain length from one to 10 carbon atoms, particularly preferably from one to 6 carbon atoms, most particularly preferably selected from methanol, ethanol, propanol, butanol and hexanol, more preferably still 2-propanol, is used as the polar solvent.

According to the invention, the mixture of extraction agents contains the nonpolar solvent in a proportion of 45 to 95 vol %, particularly preferably 55 to 85 vol %, most particularly preferably 55 to 75 vol %, still more preferably 60 vol %, measured with reference to the total volume of the extraction agent.

For the moist extraction described in this patent, mixtures of at least one polar and one nonpolar solvent are used, mainly an alkane and an alcohol. Suitable mixtures for the moist extraction described here are mixtures with an alkane content of at least 50 wt %, preferably between 55 and 95 wt % and particularly between 55 wt % and 85 wt %.

The mixture of extraction agents preferably contains the at least one polar solvent in a proportion of 5 to 55 vol %, particularly preferably 15 to 45 vol %, most particularly preferably 25 to 45 vol %, still more preferably 40 vol %, measured with reference to the total volume of the extraction agent.

The mixture of extraction agents preferably contains further polar and/or nonpolar solvents in a volumetric proportion of 0.5 to 40 vol %, particularly preferably 0.5 to 35 vol %, most particularly preferably 0.5 to 19 vol %, measured with reference to the total volume of the mixture of extraction agents. The further polar and/or nonpolar solvents are selected from the polar and nonpolar solvents according to the invention.

Alternatively, but not exclusively, binary, tertiary or higher mixtures of various alcohols such as methanol, ethanol, propanol and butanol etc. may also be used as the alcohol phase and mixtures of pentane, hexane, heptane, gasoline or kerosene and the like may be used as the alkane phase. Mixtures based on acetone and toluene are also possible.

When adjusting the mixture, it is advisable to ensure that the alcohol phase is miscible both with water and with the alkane phase. If this is done, moist materials can be extracted directly, with very little or no drying.

The mixture of extraction agents is preferably introduced at a temperature above ambient temperature but below the boiling point of the lowest boiling solvent or the lowest boiling azeotrope of the mixture of extraction agents. An azeotrope is a mixture of at least two solvents whose vapour phase has the same composition as the liquid phase, which renders separation of the at least two solvents by distillation impossible.

Like all chemical and physical processes, the efficiency of the extraction process improves as the temperature rises. The maximum working temperature corresponds to the boiling point of the most volatile component in the extraction solution, which may itself be an azeotrope of various components.

The temperature is advantageously also set at a level that ensures that the oil-containing components to be extracted are not adversely affected by the heat acting on them.

A warm mixture of extraction agents at a temperature from 35 to 69° C. is preferred, particularly preferably from 50 to 65° C., most particularly preferably from 58 to 63° C. The temperature is advantageously only slightly (0 to 6° C.) below the boiling point of n-hexane (boiling point: 69° C.).

The use of a warm mixture of extraction agents advantageously increases the degree of extraction, i.e., at a higher temperature a greater quantity of oil-containing components can be removed with a mixture of extraction agents than with the same volume of extraction agent mixture only at ambient temperature.

Coffee beans and/or residues from coffee production are preferably used with an average grain size from 0.001 to 10 mm, particularly preferably from 0.01 to 5 mm, most particularly preferably from 0.01 to 2 mm. In a particular variant of the invention, at least 30 percent by mass of the coffee beans and/or residues from coffee production measured with reference to the total weight of the coffee beans and/or residues from coffee production have a average grain size smaller than or equal to 2 mm.

Within the meaning of the invention, grain size refers to the average size distribution of the particles in a mixture of coffee beans and/or residues from coffee production.

It is advantageous for the efficiency of the process if the oil-bearing material is as fine as possible. The smaller the particles of oil-bearing material, the faster and more efficiently the extraction agent is able to penetrate and dissolve the oil. If the ratio of surface area to volume is too small, the extraction agent will take too long to penetrate, and substantial quantities of the extraction agent will also remain in the material after the miscella has been drawn off. The term miscella describes a mixture of substances consisting of an extraction (mixture) and at least one extracted oil.

Alternatively or additionally thereto, the oil-bearing material may also be ground to obtain an optimal material size beforehand. In this case, the maximum particle size should be less than 5 mm, and preferably less than 2 mm. Particle sizes below 1 mm are particularly desirable, wherein at least 30 wt % of the oil-bearing material should have a particle size smaller than 2 mm in the dry state.

Preferably, coffee beans and/or residues from coffee production are used with a content of oil-containing components from 5 to 60 percent by mass of the dry mass, particularly preferably from 10 to 45 percent by mass of the dry mass, most particularly preferably from 15 to 35 percent by mass of the dry mass in the total dry mass of the coffee beans and/or residues from coffee production.

According to the invention, total dry mass refers to the total mass of the coffee beans and/or residues from coffee production after they have been dried completely to constant mass.

Advantageously, 50 to 100 percent by mass, particularly preferably 65 to 99 percent by mass, most particularly preferably 70 to 99 percent by mass of the oil-containing components, measured with reference to the total mass of the coffee beans and/or the residues from coffee production can be extracted.

The oil-containing components are preferably separated from the mixture of extraction agents by distillation after extraction.

The extracted oil-containing components may be separated from the mixture of extraction agents in several stages, for example, wherein the most volatile component is released first, followed successively by the less readily volatile components. Advantageously, a mixture of extraction agents may be reconstituted from the recovered solvent.

The oil is separated from the solvent by distilling the miscella, as in an conventional extraction process based on hexane as the extraction agent. Distillation not only separates the oil from the extraction solution, the components of the extraction agent can also be separated from each other. If they are collected in the same receptacle and combined, the mixture can be reused as the extraction agent. If the individual components are separated, the extraction agent may be adjusted to varying properties of the extraction material while the process is ongoing, if such is permitted by the configuration of the system. The differing components of the extraction agent mean that the individual components have varying tendencies to remain in the oil-free base material. As a consequence, the proportional composition of the extraction solution changes over time and the ratio of the components deviates from the preset, optimal range. Accordingly, the composition of the extraction solution must be checked regularly and readjusted as necessary. This may be done by density analysis, for example, but other methods such as fluorescence measurements are also conceivable. Fluorescence measurements may also be used to check the oil content in the miscella and determine when saturation has been reached and the solvent must be replaced.

In a particular variant of the invention, mixtures of 50 wt %-95 wt % n-hexane and 5 wt % to 50 wt % 2-propanol are used to extract oil-containing components from coffee beans and/or residues from coffee production to recover 70-98 wt % of the oil from materials (coffee beans and/or residues from coffee production) with a moisture content between 55 and 75 wt % and an oil content between 15 and 35 wt % in the dry mass without drying.

In this context, it is particularly preferred if the oil is also miscible with the alcohol phase and ideally is also soluble therein. Under these circumstances, it is possible to elute over 90% of the oil from moist, oil-containing material and separate it from the extraction agent by distillation, as in a conventional extraction method with n-hexane as solvent.

In principle, the moisture extraction process may be operated on all systems that are designed to carry out hexane extraction, such has percolation and continuous belt systems. Only the distillation unit must be capable of operating at higher temperatures than that for use with pure hexane, since most of the alcohols have a higher boiling point than hexane. It may be necessary to fit seals which are able to withstand both alkanes and alcohols. It should also be noted that dyes and suspended solids which are not normally present in the oil in pure hexane extraction may also be transferred from the material to the extract. This is because of the alcohol phase, which enables some degree of transfer of hydrophilic substances. In order to remove these from the oil, an additional filtering step may be integrated in the process so that any suspended solids may be removed from the oil. Further processing of the oil takes place in an oil refinery after separation of the solvent and filtration, and is not a part of this method. The alcohol phase in the process may also be reduced to optimise the purity of the oil if the extraction efficiency is not impaired thereby or remains within acceptable limits.

Centrifuges or presses may be utilised after the method as appropriate for the material to separate any remaining extraction solution from the oil-free raw material.

The method according to the invention is associated with operating and initial investment costs that compare very favourably with those of the aforementioned conventional and non-standard extraction methods. The method according to the invention thus provides a simple, universally applicable, efficient, economical method for extracting triglyderide-based vegetable oils from materials that are still moist, such as coffee beans and/or residues from coffee production. The method according to the invention may be carried out advantageously on all conventional extraction systems, if necessary with minimal modifications.

Surprisingly, it has been found that very good yields of oil-containing components such as triglycerides can be extracted from vegetable matter such as coffee beans and/or residues from coffee production regardless of the water content and without drying in a mixture of extraction agents consisting of polar and nonpolar solvents with a higher proportion of nonpolar solvent.

According to a particular variant of the invention, the coffee beans and/or residues from coffee production are extracted multiple times using a fresh mixture of extraction agents. Preferably, the extraction is carried out from one to 10 times, particularly preferably one to 7 times, most particularly preferably one to 5 times, still more preferably three times. This advantageously increases the degree of extraction, i.e. more oil-containing component is obtained from the coffee beans and/or residues from coffee production. Advantageously, the individual mixtures of extraction agents that are obtained after multiple extraction cycles from the coffee beans and/or residues from coffee production with a fresh mixture of extraction agents each time are combined. The oil-containing components are removed from the combined mixtures of extraction agents by distillation.

The present method essentially treats of a method for increasing the dissolving efficiency of the extraction from moist materials, with which it is possible for the first time to conduct extraction from moist materials in an energy and cost efficient manner without drying beforehand.

### DETAILED DESCRIPTION OF THE PREFERRED EMBODIMENTS

The invention will now be explained in greater details with reference to the embodiments listed, but without limitation thereto.

### Example 1—Moist Extraction with Industrial Coffee Grounds

For extraction using binary extraction solutions, fresh, moist Robusta coffee grounds from industrial instant coffee production with a water content of 68% and an oil content of 17.3% in the dry mass were used.

Portions of 27 and 28 g moist coffee grounds were each deposited separately in a filter having a pore size of 100 μm and collected in a beaker. The beakers were each filled with 100 ml extraction solution of compositions of various mixtures of n-hexane and 2-propanol in volumetric proportions between 45:55 and 85:15, and one beaker with pure hexane. Both the mixtures and the pure hexane were warmed to 60° C. The samples were allowed to rest in the extraction solutions for 10 min and then removed. The samples were then allowed to drip for a further minute. Then, the recovered miscellae were distilled, and the recovered oil was analysed gravimetrically. The coffee grounds were also dried to determine the mass of the respective sample and thus determine the maximum recoverable oil quantity. This theoretical oil quantity and the actually recovered oil quantity were subsequently compared. With moist extraction it was possible to recover between 50 and 95 percent by mass of the oil, wherein the yield with an n-hexane component of 70 and 85 vol % was between 90 and 97%. Outside of this optimal range, extraction efficiency fell sharply, and with pure n-hexane (100 vol %) the yield was 0%.

### Example 2—Moist Extraction with Decanter Slurry From Instant Coffee manufacture

For moist extraction, fresh, moist decanter slurry from the manufacture of instant coffee with a water content of 75.4% and an oil content of 14.6% in the dry mass was used. The decanter slurry originated from the industrial instant coffee production. Portions between 42 and 43 g of moist decanter slurry were each placed in separate beakers and dispersed in 48 to 49 g extraction solution at 60° C. The extraction solutions were various mixtures of n-hexane and 2-propanol with volumetric proportions between 45:55 and 70:30. The material remained in the extraction solutions for 20 min. The miscellae were then filtered and distilled, and the quantity of recovered oil was determined gravimetrically. With moist extraction it was possible to recover between 50 and 99 percent by mass of the oil from decanter slurry without drying.

### Example 3—Moist Extraction with Industrial Arabica Coffee Grounds

For this experiment, deep frozen industrial Arabica coffee grounds having a residual moisture of 60.4% and an oil content of 31.2% in the dry mass were analysed. The coffee grounds were stored in the refrigerator 7° C. for 24 to thaw them. For the experiments, a 65:35 (n-hexane:2-propanol) extraction solution was used. 50 g coffee ground was deposited in a filter and placed in a beaker. The sample was infused with with 100 ml of a mixture of extraction agents, which was warmed to 60° C., poured out and allowed to rest for 15 min. Then, the miscella was drawn off and washed three times, each time with 30 ml warm extraction agent mixture. In this way, it was possible to recover 89% of the oil, whereas an experiment with warm n-hexane yielded less than 1%.

1. Method for moist extraction of oil-containing components from coffee beans and/or residues from coffee production, wherein the coffee beans and/or residues from coffee production with a residual moisture content of 10 to 95 percent by mass, measured with reference to the total mass of the coffee beans and/or residues from coffee production, are extracted using a mixture of extraction agents consisting of at least one polar and one nonpolar solvent, and wherein the mixture of extraction agents contains the at least one nonpolar solvent in a percentage of 45 to 95 vol %, measured with reference to the total volume of the extraction agent.

2. Method according to claim 1, characterised in that gasoline, kerosene, toluene, an alkane having a chain length of 5 to 25 carbon atoms or a mixture thereof is used as the at least one nonpolar solvent.

3. Method according to claim 1, characterised in that an alcohol having a chain length from one to 10 carbon atoms is used as the at least one polar solvent.

4. Method according to claim 1, characterised in that the mixture of extraction agents contains the at least one polar solvent in a proportion of 5 to 55 vol %, measured with reference to the total volume of the extraction agent.

5. Method according to claim 1, characterised in that the mixture of extraction agents contains further polar and/or nonpolar solvents with a proportion by volume totaling 0.5 to 40 vol %, measured with reference to the total volume of the mixture of extraction agents.

6. Method according to claim 1, characterised in that the mixture of extraction agents is used at a temperature above ambient temperature but below the boiling point of the solvent with the lowest boiling point or the boiling point of the azeotrope with the lowest boiling point in the mixture of extraction agents.

7. Method according to claim 1, characterised in that coffee beans and/or residues from coffee production having an average grain size from 0.001 to 10 mm are used.

8. Method according to claim 1, characterised in that coffee beans and/or residues from coffee production having a content of oil-containing components from 5 to 60 percent by mass, measured with reference to the total dry matter of the coffee beans and/or residues from coffee production are used.

9. Method according to claim 1, characterised in that the oil-containing components are separated from the mixture of extraction agents by distillation after the extraction.
